(19) United States
(12) Patent Application Publication
(10) Pub. No.: US 2025/0094813 A1
(43) Pub. Date: Mar. 20, 2025

(54) TRAINING A TRANSFORMER NEURAL NETWORK TO PERFORM TASK-SPECIFIC PARAMETER SELECTION

(71) Applicant: NVIDIA CORPORATION, Santa Clara, CA (US)

(72) Inventors: Wonmin BYEON, Santa Cruz, CA (US); Sudarshan BABU, Chicago, IL (US); Shalini DE MELLO, San Francisco, CA (US); Jan KAUTZ, Lexington, MA (US)

(21) Appl. No.: 18/471,204

(22) Filed: Sep. 20, 2023

(51) Int. Cl. G06N 3/0895

(52) U.S. Cl. CPC G06N 3/0895

(57) ABSTRACT

One embodiment of the present invention sets forth a technique for training a transformer neural network. The technique includes inputting a first task token and a first set of samples into the transformer neural network and training the transformer neural network using a first set of losses between predictions generated by the transformer neural network from the first task token and first set of samples as well as a first set of labels. The technique also includes converting the first task token into a second task token that is larger than the first task token, inputting the second task token and a second set of samples into the transformer neural network, and training the transformer neural network using a second set of losses between predictions generated by the transformer neural network from the second task token and the second set of samples as well as a second set of labels.

### BACKGROUND

### Field of the Various Embodiments

Embodiments of the present disclosure relate generally to machine learning and artificial intelligence and, more specifically, to training a transformer neural network to perform task-specific parameter selection.

### DESCRIPTION OF THE RELATED ART

Machine learning generally refers to computer-based techniques that leverage data to perform or improve the performance of various tasks. A typical machine learning workflow involves training a machine learning model to perform a task using a large set of training data, instead of providing explicit instruction or rules to software and/or hardware for carrying out the task. For example, a machine learning model could be trained to perform a classification task that assigns an input (e.g., an image, audio, video, text, etc.) to one or more predefined categories (e.g., an object, concept, emotion, or another entity represented by or found in the input). In another example, a machine learning model could be trained on a regression task that involves predicting a continuous value such as a price, temperature, energy consumption, fuel efficiency, life expectancy, and/or credit risk. In both examples, the parameters of the machine learning model could be iteratively updated to minimize an error between different predictions of categories or different continuous values generated by the machine learning model based on inputted training samples and the corresponding “ground truth” categories or values assigned to the training samples.

However, a machine learning model that is trained under a conventional machine learning workflow typically experiences catastrophic forgetting, where the machine learning model “forgets” previously acquired knowledge as soon as the model is trained on new data and/or to perform a new task. For example, a neural network could initially be trained to distinguish between images of cats and images of dogs. When the neural network is subsequently trained to distinguish between images of dragonflies and images of lizards, the neural network could lose the ability to accurately distinguish between images of cats and images of dogs. This type of catastrophic forgetting occurs when the parameters of the machine learning model are changed or overwritten by the most recently learned concepts, thereby causing the machine learning model to “lose” or “forget” earlier learned patterns.

Catastrophic forgetting occurs even more strongly under a few-shot learning paradigm, in which a machine learning model is trained to perform new tasks with relatively few training samples. For example, a neural network that is trained on a sequence of tasks that involve classifying images of different types of objects using a relatively large number of samples of each object class could experience a 40% decrease in accuracy in recognizing the first learned object class after being introduced to 100 object classes. However, a neural network that is trained on a sequence of tasks that involve classifying images of different types of objects using only a few samples of each object class could experience the same 40% decrease in accuracy in recognizing the first learned object class after being introduced to only 30 object classes. This acceleration in catastrophic forgetting under the few-shot learning scenario occurs because rapid change to the parameters of the machine learning model that allow the machine learning model to adapt to limited data for each new task can interfere with the ability of the machine learning model to retain knowledge learned during previous tasks.

As the foregoing illustrates, what is needed in the art are more effective techniques for retraining machine learning models to perform sequences of tasks.

### SUMMARY

One embodiment of the present invention sets forth a technique for training a transformer neural network. The technique includes inputting a first task token and a first set of samples included in a training dataset into the transformer neural network and training the transformer neural network based on a first set of losses computed between a first set of predictions generated by the transformer neural network from the first task token and the first set of samples as well as a first set of labels for the first set of samples. The technique also includes converting the first task token into a second task token that is larger than the first task token and inputting the second task token and a second set of samples included in the training dataset into the transformer neural network. The technique further includes performing a plurality of training operations on the transformer neural network based on a second set of losses computed between a second set of predictions generated by the transformer neural network from the second task token and the second set of samples as well as a second set of labels for the second set of samples, wherein, once trained, the transformer neural network generates a third task token from at least a portion of a data sample and performs a task associated with the data sample based on the third task token

One technical advantage of the disclosed techniques relative to the prior art is that the disclosed techniques enable a machine learning model to adapt more readily to a new task by better leveraging the knowledge gained when previously trained for some other task. Consequently, with the disclosed techniques, a machine learning model can be trained to perform each new task more quickly and/or using fewer samples per task than conventional approaches that involve using large sets of training data and many training iterations to train a machine learning model to perform each task. Further, with the disclosed techniques, a machine learning model is able to adapt continually to new tasks without substantially overwriting the ability of the machine learning model to perform previously learned tasks. Accordingly, machine learning models trained using the disclosed techniques can perform more tasks and perform individual tasks more accurately than conventional machine learning models that oftentimes exhibit catastrophic forgetting of previously learned tasks after being subsequently trained for new tasks. The disclosed techniques are especially useful with machine learning models trained under few-shot training paradigms, where catastrophic forgetting is particularly prominent. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of the various embodiments.

FIG. 2 is a more detailed illustration of the meta-training engine and meta-testing engine of FIG. 1, according to various embodiments.

FIG. 3A illustrates an exemplar architecture for the task-specific attention module of FIG. 2, according to various embodiments.

FIG. 3B illustrates an exemplar architecture for the task mask of FIG. 3A, according to various embodiments.

FIG. 3C illustrates another exemplary implementation of the task-specific attention module of FIG. 2, according to other various embodiments.

FIG. 4 illustrates how the meta-training engine of FIG. 1 performs meta-training of the representation learning network and prediction learning network of FIG. 2, according to various embodiments.

FIG. 5 sets forth a flow diagram of method steps for performing meta-training of a machine learning model, according to various embodiments.

FIG. 6 sets forth a flow diagram of method steps for performing meta-testing of a machine learning model, according to various embodiments.

FIG. 7 sets forth a flow diagram of method steps for training a transformer neural network, according to various embodiments.

FIG. 8 sets forth a flow diagram of method steps for executing a transformer neural network, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### General Overview

Machine learning refers to techniques that leverage data to perform or improve performance on various tasks. A typical machine learning workflow involves training a machine learning model to perform a task using a large set of training data instead of providing explicit instruction or rules for carrying out the task. For example, a machine learning model could be trained to perform a classification task that assigns an input (e.g., an image, audio, video, text, etc.) to one or more predefined categories (e.g., an object, concept, emotion, or another entity represented by or found in the input). In another example, a machine learning model could be trained on a regression task that involves predicting a continuous value such as a price, temperature, energy consumption, fuel efficiency, life expectancy, and/or credit risk. In both examples, the parameters of the machine learning model could be iteratively updated to minimize an error between predictions of categories or continuous values generated by the machine learning model from a large number (e.g., hundreds to thousands) of inputted training samples and the corresponding “ground truth” categories or values in assigned to the training samples.

However, a machine learning model that is trained under a conventional machine learning workflow typically experiences catastrophic forgetting, in which the machine learning model “forgets” previously acquired knowledge after being trained on new data and/or to perform a new task. For example, a neural network could initially be trained to distinguish between images of cats and images of dogs. When the neural network is subsequently trained to distinguish between images of dragonflies and images of lizards, the neural network could lose the ability to accurately distinguish between images of cats and images of dogs. This catastrophic forgetting occurs when the parameters of the machine learning model are changed or overwritten by the most recently learned concepts, thereby causing the machine learning model to lose earlier learned patterns.

Catastrophic forgetting occurs even more strongly under a few-shot learning paradigm, in which a machine learning model is trained to perform new tasks with relatively few training samples. For example, a neural network that is sequentially trained to classify images of different types of objects using a relatively large number of samples of each object class could experience a 40% decrease in accuracy in recognizing the first learned object class after learning 100 object classes. However, a neural network that is sequentially trained to classify images of different types of objects using only a few samples of each object class could experience the same 40% decrease in accuracy in recognizing the first learned object class after learning only 30 object classes.

To improve the performance of machine learning models in learning sequences of tasks and/or learning to perform new tasks with few training samples, the disclosed techniques provide a task-specific sparse attention module that can be used in a neural network with a transformer architecture. The task-specific sparse attention module encodes an input token into a query, a key, and multiple values. The values are used to compartmentalize the task-specific sparse attention module into distinct sub-units that are selectively activated to perform different tasks. The values are scaled using attention scores computed between pairs of input tokens to generate multiple corresponding outputs. A task token that encodes different sets of tasks is combined with the input tokens and used to generate an output task token. The output task token is used to determine scores representing the relative importances of the sub-units to the task associated with the input. These scores are additionally combined with the outputs into a final output for the input token, thereby allowing different tasks to be performed using different combinations of sub-units within the task-specific sparse attention module.

The disclosed techniques additionally provide a training technique that can be used with the task-specific attention module and/or other types of neural network architectures or components. The training technique includes one or more inner loops that introduce tasks to the machine learning model in a sequential manner and an outer loop that performs optimization between a current task and previous tasks to allow the machine learning model to remember earlier tasks. Both types of loops can involve training the machine learning model to learn representations of different types of images (or other types of data) by having the model perform a self-supervised learning task, such as filling in missing patches or portions of the data.

### System Overview

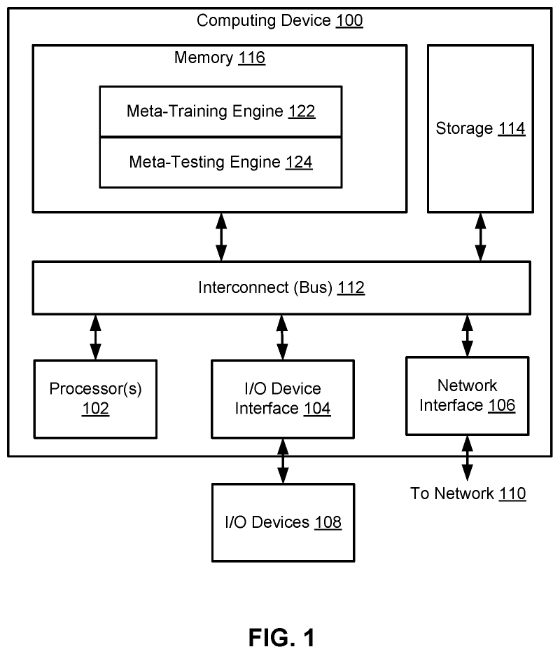

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a meta-training engine 122 and a meta-testing engine 124 that reside in a memory 116.

It is noted that the computing device described herein is illustrative and that any other technically feasible configurations fall within the scope of the present disclosure. For example, multiple instances of meta-training engine 122 and meta-testing engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and meta-testing engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including meta-training engine 122 and meta-testing engine 124.

In some embodiments, meta-training engine 122 and meta-testing engine 124 operate to train and execute a machine learning model under a few-shot continual learning paradigm, in which the machine learning model learns to perform a sequence of tasks using a limited number of training samples per task. More specifically, meta-training engine 122 and meta-testing engine 124 include functionality to improve the performance of the machine learning model in learning sequences of tasks and/or learning to perform new tasks with relatively few training samples. First, meta-training engine 122 and meta-testing engine 124 can employ a transformer architecture with a task-specific sparse attention module in the machine learning model. The task-specific sparse attention module includes distinct sub-units that can be sparsely activated to allow the machine learning model to perform different tasks.

Second, meta-training engine 122 can train the machine learning model using a training technique that includes one or more inner loops and an outer loop. The inner loop(s) introduce tasks to the machine learning model in a sequential manner, and the outer loop performs optimization between a current task and previous tasks to allow the machine learning model to remember earlier tasks. Both types of loops involve training the machine learning model to learn representations of different types of images (or other types of data) by having the model perform a self-supervised learning task, such as filling in missing patches or portions of the data. Meta-training engine 122 and meta-testing engine 124 are described in further detail below.

Few-Shot Continual Learning with Task-Specific Parameter Selection and Self-Supervised Training Tasks

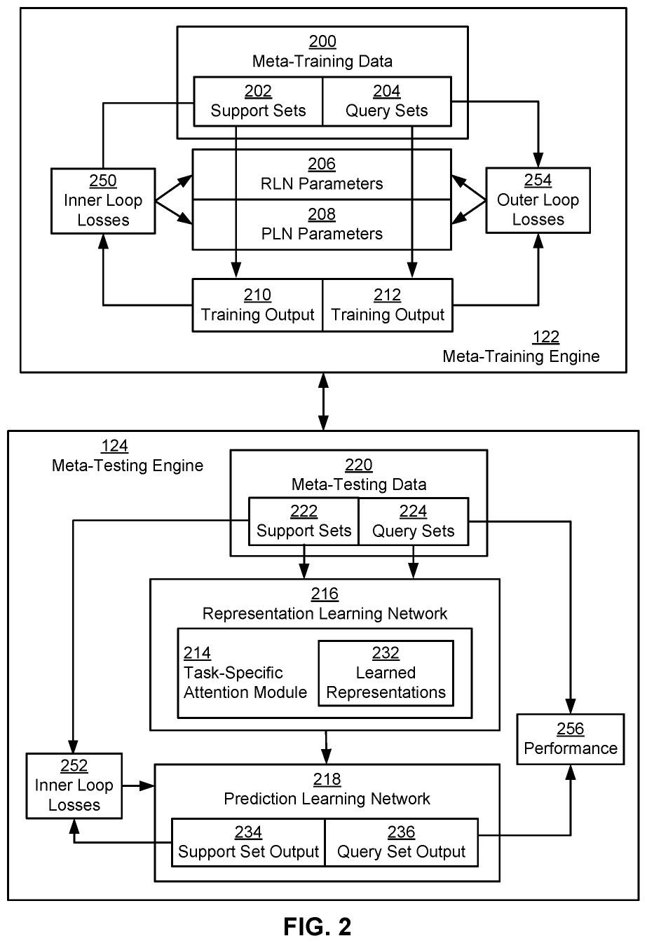

FIG. 2 is a more detailed illustration of meta-training engine 122 and meta-testing engine 124 of FIG. 1, according to various embodiments. As mentioned above, meta-training engine 122 and meta-testing engine 124 operate to train and execute a machine learning model under a few-shot continual learning paradigm.

As shown in FIG. 2, the machine learning model includes a representation learning network 216 and a prediction learning network 218. Representation learning network 216 includes one or more convolutional neural networks, fully connected neural networks, recurrent neural networks, residual neural networks, transformer neural networks, autoencoders, variational autoencoders, generative adversarial networks, and/or other types of neural networks that generate learned representations 232 of a set of inputs. For example, representation learning network 216 could convert input images associated with different classes of objects (e.g., different types of animals, faces, written characters, inanimate objects, etc.) into learned representations 232 in a lower-dimensional latent space.

Prediction learning network 218 includes one or more convolutional neural networks, fully connected neural networks, recurrent neural networks, residual neural networks, transformer neural networks, autoencoders, variational autoencoders, generative adversarial networks, and/or other types of neural networks that operates on learned representations 232 to generate various types of outputs (e.g., support set output 234, query set output 236, etc.) associated with the inputs. Continuing with the above example, prediction learning network 218 could include a classifier that converts a given learned representation of an input image into output scores representing predicted probabilities of different classes for the input image. Prediction learning network 218 could also, or instead, generate bounding boxes, semantic segmentations, and/or other types of predictive output for different types of objects in the input image.

Representation learning network 216 also includes a set of RLN parameters 206, and prediction learning network 218 includes a set of PLN parameters 208. In some embodiments, RLN parameters 206 include neural network weights that are updated based on one or more losses during training of representation learning network 216, and PLN parameters 208 include neural network weights that are updated based on one or more losses during training of prediction learning network 218, as discussed in further detail below.

Under the few-shot continual learning paradigm, representation learning network 216 and prediction learning network 218 learn to perform a sequence of tasks using a limited number of training samples per task. Continuing with the above example, representation learning network 216 could be used to convert a series of images depicting different classes of objects into a series of corresponding learned representations 232. Prediction learning network 218 could be trained to predict classes of objects depicted in the images based on input that includes learned representations 232 from representation learning network 216. Losses associated with predictions from prediction learning network 218 could then be used to update PLN parameters 208 of prediction learning network 218 and/or RLN parameters 206 of representation learning network 216. Thus, over time, representation learning network 216 could generate learned representations 232 that reflect differences in visual attributes across different classes of objects, and prediction learning network 218 could use these learned representations 232 to predict classes for new objects without losing the ability to predict classes for older objects.

In one or more embodiments, representation learning network 216 includes a task-specific attention module 214 that uses different subsets of RLN parameters 206 to perform different tasks. For example, representation learning network 216 could include a series of convolutional blocks followed by a series of transformer blocks. Each convolutional block could include a convolutional layer, a batch normalization layer, a rectified linear unit (ReLU) activation function, and a max pooling layer. Each transformer block operates on tokens representing regions of images and/or other discrete units of input data. Each transformer block could include a layer normalization, task-specific attention module 214, and a ReLU activation function.

As described in further detail below, task-specific attention module 214 divides a problem space of continual learning tasks into different sub-units. During processing of a given input, sub-units that are relevant to the corresponding task could be selected to contribute to the prediction associated with the task.

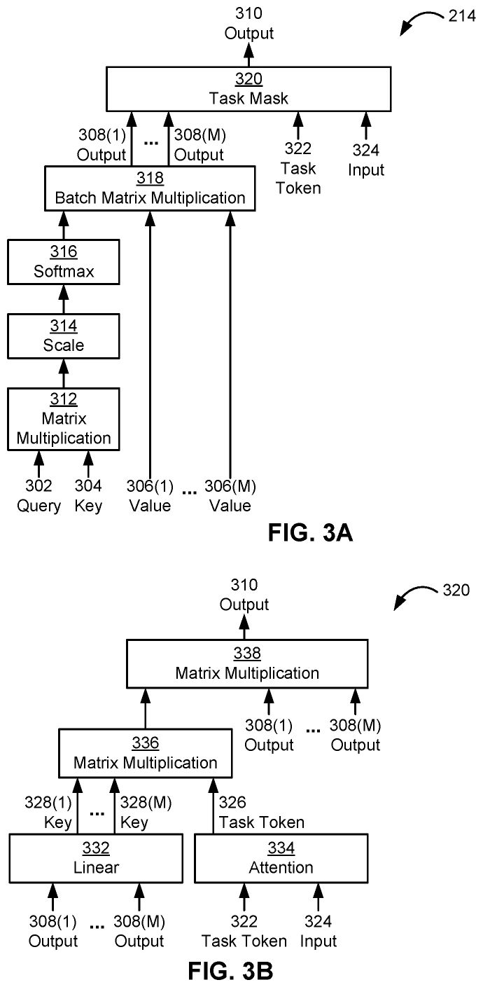

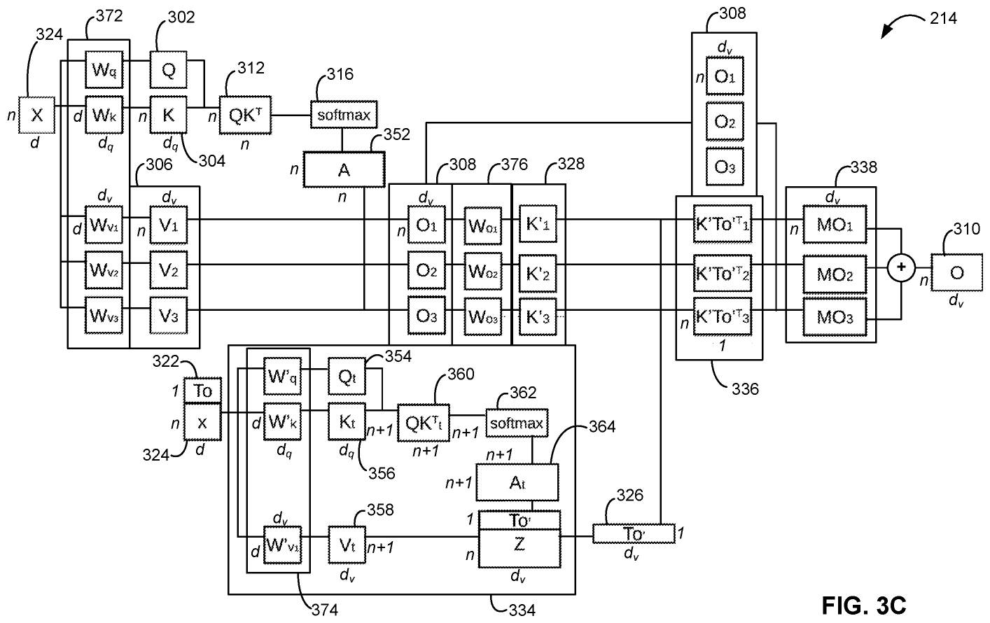

FIG. 3A illustrates an exemplar architecture for task-specific attention module 214 of FIG. 2, according to various embodiments. As shown in FIG. 3A, input into task-specific attention module 214 includes a query 302, a key 304, and multiple values 306(1)-306(M) (each of which is referred to herein individually as value 306). Query 302, key 304, and values 306(1)-306(M) can be generated via linear transformations of an input 324, such as one or more embeddings and/or tokens representing discrete portions of a data sample (e.g., an image, a sequence of text, etc.). For example, query 302, key 304, and values 306(1)-306(M) could be generated by multiplying input 324 and/or other inputs with three different sets of weights.

Task-specific attention module 214 also includes a matrix multiplication 312 layer and a scale 314 layer that are used to compute a scaled cosine similarity between query 302 and key 304. This scaled cosine similarity is provided to a softmax 316 layer that generates attention scores between vectors in query 302 and vectors in key 304.

The attention scores from softmax 316 are inputted along with values 306(1)-306(M) into a batch matrix multiplication 318 layer, which scales values 306(1)-306(M) using the attention scores to produce multiple outputs 308(1)-308(M) (each of which is referred to herein individually as output 308). These outputs 308(1)-308(M) are then inputted with a concatenation (or another combination of) a task token 322 and the original input 324 into a task mask 320. Task mask 320 performs a selection procedure using outputs 308(1)-308(M), task token 322, and input 324 to generate a final output 310 that represents a selection of a subset of values 306(1)-306(M) for use in a task related to input 324.

FIG. 3B illustrates an exemplar architecture for task mask 320 of FIG. 3A, according to various embodiments. As mentioned above, input into task mask 320 includes outputs 308(1)-308(M) generated by batch matrix multiplication 318, task token 322, and input 324.

As shown in FIG. 3B, outputs 308(1)-308(M) are processed by a linear 332 layer to compute corresponding keys 328(1)-328(M) (each of which is referred to herein individually as key 328). An attention 334 unit converts the combination of task token 322 and input 324 into an output task token 326. A matrix multiplication 336 layer uses another scaled cosine similarity and softmax to convert keys 328(1)-328(M) and task token 326 into a set of scores. Another matrix multiplication 338 layer combines these scores with outputs 308(1)-308(M) into the final output 310.

In one or more embodiments, scores generated by matrix multiplication 336 from keys 328(1)-328(M) and task token 326 correspond to mask values that are used to select a subset of outputs 308(1)-308(M) for use in computing the final output 310. Each mask value can represent the contribution of a corresponding output 308(1)-308(M) to the final output 310. For example, mask values generated by matrix multiplication 336 could include soft mask values that scale outputs 308(1)-308(M) by values ranging between 0 and 1, so that certain outputs 308(1)-308(M) that are more relevant to the task are weighted more in the final output 310 than other outputs 308(1)-308(M) that are less relevant to the task. In another example, mask values generated by matrix multiplication 336 could include hard mask values of either 0 or 1 that are generated by thresholding the soft mask values. These hard mask values could be used to switch specific outputs 308(1)-308(M) “on” or “off” in contributing to the final output 310.

Referring to the exemplar architectures of FIGS. 3A-3B, values 306(1)-306(M) and the corresponding outputs 308(1)-308(M) can represent sub-units that can be selectively leveraged to learn new tasks (e.g., tasks introduced under a continual learning paradigm) without forgetting previously learned tasks. These sub-units can be selected by task-specific attention module 214 and task mask 320 from query 302, key 304, task token 322, and input 324 to allow different learned concepts to be used in performing different tasks. The number of values M can be a hyperparameter that can be set and/or tuned.

During training, task token 322 is set to a starting size and randomly initialized. As training samples representing different tasks are introduced to task-specific attention module 214, the value and/or size of task token 322 can be updated to allow task-specific attention module 214 and task mask 320 to perform the tasks using different combinations of values 306(1)-306(M) and the corresponding outputs 308(1)-308(M).

For example, task token 322 could initially be set to a size of d, where d corresponds to a certain number of elements in a vector and/or an embedding length of input 324. During training of task-specific attention module 214, tasks could be introduced to task-specific attention module 214 under a continual learning paradigm. Each task could include one or more classes and one or more labelled training samples per class. As training samples are introduced to task-specific attention module 214, the parameters of task-specific attention module 214 and task token 322 could be updated based on one or more losses (e.g., self-supervised losses, supervised losses, etc.) computed from the data samples, the corresponding labels, and/or output generated by a neural network (e.g., representation learning network 216) that includes task-specific attention module 214 from the training samples. These updates could be performed after each training sample is processed by the neural network, after a certain number of training samples have been processed by the neural network, after a set of data samples grouped under a given task have been processed by the neural network, and/or according to another frequency. When the nth task is introduced to task-specific attention module 214, the size of task token 322 could be increased to n*d, d+n*m (where m represents an incremental per-task increase to the size of task token 322), and/or another value to allow task token 322 to accommodate the new task. As task-specific attention module 214 is trained using data samples associated with the new task, task token 322 (and the corresponding task token 326) would be updated to generate scores and/or mask values that reflect the relevance of outputs 308(1)-308(M) to the new task.

Alternatively, the size of task token 322 can be fixed during training of task-specific attention module 214. For example, task token 322 could be set to a 1 by d at the beginning of training, where d is selected to accommodate a known number of tasks to be learned by task-specific attention module 214. As task-specific attention module 214 is introduced to new tasks, the size of task token 322 could remain fixed, while the value of task token 322 could be updated to reflect the new tasks.

After training is complete, task mask 320 is used to compute attention 334 between a given learned task token 322 and input 324. Matrix multiplication 336 is also used to combine the resulting task token 326 with keys 328(1)-328(M) into mask values that represent the relevance of individual outputs 308(1)-308(M) to the task associated with input 324. Another matrix multiplication 338 is used to combine these mask values with the corresponding outputs 308(1)-308(M) into a final output 310. The final output 310 of the last task-specific attention module 214 can then be included in one or more learned representations 232 that are provided as input into prediction learning network 218 and/or another neural network that uses learned representations 232 to generate predictions.

FIG. 3C illustrates an exemplary implementation of task-specific attention module 214 of FIG. 2, according to various embodiments. As shown in FIG. 3C, input 324 is denoted by “X” and combined with different sets of weights 372 denoted by “W_{q},” “Wₖ,” “W_{V1},” “W_{V2},” and “W_{V3}” to generate query 302 denoted by “Q”, key 304 denoted by “K”, and three values 306 of “V₁,” “V₂,” and “V₃,” respectively.

More specifically, input 324 includes dimensions of n by d, each of “W_{q}” and “Wₖ” includes dimensions of d by d_{q}, and each of “W_{V1},” “W_{V2},” and “W_{V3}” includes dimensions of d by dᵥ. Input 324 is multiplied by “W_{q}” and “Wₖ” to produce query 302 and key 304, respectively, and input 324 is multiplied by “W_{V1},” “W_{V2},” and “W_{V3}” to produce the three values 306 of “V₁,” “V₂,” and “V₃,” respectively. Each of query 302 and key 304 includes dimensions of n by d_{q}, and each of values 306 includes dimensions of n by dᵥ. Thus, in the exemplary task-specific attention module 214 of FIG. 3C, n corresponds to the number of tokens into which a given data sample (e.g., image, sequence of text, etc.) is divided, d corresponds to an embedding length, d_{q}corresponds to the embedding length associated with query 302 and key 304, and dᵥ corresponds to the embedding length associated with values 306.

Query 302 and key 304 are combined via matrix multiplication 312 into a result denoted by “QK^{T},” which includes dimensions of n by n. Softmax 316 is applied to this result to produce a set of attention scores 352, which are denoted by “A” and have the same dimensions of n by n. These attention scores 352 are then multiplied with values 306 of “V₁,” “V₂,” and “V₃” to produce outputs 308 denoted by “O₁,” “O₂,” and “O₃,” respectively. Each of outputs 308 includes dimensions of n by dᵥ. Consequently, weights 372, query 302, key 304, values 306, matrix multiplication 312, softmax 316, attention scores 352, and outputs 308 correspond to an attention unit within task-specific attention module 214.

A concatenation of task token 322 denoted by “Tₒ” and input 324 is separately inputted into another attention 334 unit included in task mask 320. Within this attention 334 unit, the concatenated input is multiplied with additional sets of weights 374 denoted by “W′_{q},” “W′ₖ,” and “W′_{V1}” to generate a different query 354 denoted by “Qₜ”, a different key 356 denoted by “Kₜ”, and a different value 358 of “Vₜ,” respectively. Task token 322 includes dimensions of 1 by d, each of “W′_{q}” and “W′ₖ” includes dimensions of d by d_{q}, and “W′_{V1}” includes dimensions of d by dᵥ. Each of query 354 and key 356 includes dimensions of n+1 by d_{q}, and value 358 includes dimensions of d by dᵥ.

Query 354 and key 356 are combined via another matrix multiplication 360 into a result denoted by “QK^{T}t,” which includes dimensions of n+1 by n+1. Another softmax 362 is applied to this result to produce a different set of attention scores 364, which are denoted by “Aₜ” and have the same dimensions of n+1 by n+1. These attention scores 364 are then multiplied with value 358 to produce an output with a first row denoted by “Tₒ,” and remaining rows denoted by “Z.” This first row of output is obtained as the output task token 326 generated by attention 334. Task token 326 includes dimensions of 1 by dᵥ.

Outputs 308 are scaled by linear 332 layer using weights 376 that are denoted by “W₀₁,” “W₀₂,” and “W₀₃” and include the same dimensions of n by dᵥ to generate keys 328 denoted by “K′₁,” “K′₂,” and “K′₃,” respectively. Each of keys 328 also includes the same dimensions of n by dᵥ. Matrix multiplication 336 is then used to combine keys 328 with task token 326 into results that are denoted by “K′Tₒ,T₁,” “K′Tₒ,T₂,” and “K′Tₒ,T₃,” respectively. Each of “K′Tₒ,T₁,” “K′Tₒ,T₂,” and “K′Tₒ,T₃” includes dimensions of n by 1 and corresponds to a set of mask values that are combined with outputs 308 via matrix multiplication 338 into results denoted by “MO₁,” “MO₂,” and “MO₃,” respectively. Each of these results includes dimensions of n by dᵥ and corresponds to scaling of an output by values ranging between 0 and 1. Finally, the results denoted by “MO₁,” “MO₂,” and “MO₃” results are summed to produce the final output 310, which also includes dimensions of n by dᵥ.

While the implementation of task-specific attention module 214 illustrated in FIG. 3C includes three values 306 and three outputs 308, it will be appreciated that the number of values 306 and corresponding outputs 308 can be varied to reflect the types and/or numbers of tasks to be learned and/or performed using task-specific attention module 214. For example, the number of values 306 and corresponding outputs 308 could be manually set and/or optimized for the continual learning problem associated with task-specific attention module 214. Different subsets of values 306 and corresponding outputs 308 can then be selected for different tasks based on input 324 and task token 322.

As mentioned above, the size of task token 322 can optionally be increased to accommodate new tasks introduced under a continual learning paradigm. For example, in the exemplar architecture of FIG. 3C, the dimension d could be incremented by 1 (or by another value) prior to training task-specific attention module 214 on training samples from a new task. As d increases in size, other components of task-specific attention module 214 are also updated to generate new queries 302 and 354, keys 304 and 356, values 306, mask values, outputs 308 and 310, and/or other results that allow task-specific attention module 214 to adapt to the new tasks without forgetting previously learned tasks.

Returning to the discussion of FIG. 2, while task-specific attention module 214 has been illustrated and described as a component of representation learning network 216, it will be appreciated that task-specific attention module 214 can be incorporated into various types of neural networks and/or neural network architectures. For example, task-specific attention module 214 could be used in self-attention blocks, task-attention blocks, and/or other attention blocks in a Dynamic Token Expansion (DyTox) transformer model. In another example, task-specific attention module 214 could be used as a replacement for a convolutional block, conventional self-attention unit, multi-layer perceptron (MLP), and/or another component of a deep neural network. In a third example, task-specific attention module 214 could be used with an Attentive Independent Mechanisms (AIM) module between representation learning network 216 and prediction learning network 218. The AIM module includes a set of independent mechanisms, each with a separate set of parameters. The AIM module selects, from the set of independent mechanisms, a smaller sparse set of mechanisms that are closely related to the input representation from representation learning network 216 to be used in a downstream prediction task.

In one or more embodiments, meta-training engine 122 uses a set of meta-training data 200 to perform meta-training of representation learning network 216 and prediction learning network 218. As shown in FIG. 2, meta-training data 200 includes a series of support sets 202 and a corresponding series of query sets 204. Each support set in meta-training data 200 includes labeled examples that are from a certain set of classes and/or otherwise represent a certain set of tasks. For example, each support set could include K labelled examples for each of N classes. Each support set could be paired with a query set (e.g., in query sets 204) of additional labeled examples from the same N classes. The query set could also, or instead, include additional labeled examples from classes or tasks associated with earlier support sets 202 (e.g., classes or tasks that have already been introduced to representation learning network 216 and prediction learning network 218).

During meta-training of representation learning network 216 and prediction learning network 218, meta-training engine 122 iteratively trains prediction learning network 218 using the sequence of support sets 202 and corresponding query sets 204. More specifically, meta-training engine 122 performs one or more “inner loops” that use representation learning network 216 and/or prediction learning network 218 to convert examples from a given support set into a corresponding set of training output 210. Meta-training engine 122 computes one or more inner loop losses 250 between the set of training output 210 and labels for the examples in the support set. Meta-training engine 122 then uses a training technique (e.g., gradient descent and backpropagation) to update PLN parameters 208 of prediction learning network 218 and/or RLN parameters 206 of representation learning network 216 in a way that reduces inner loop losses 250.

After PLN parameters 208 and/or RLN parameters 206 have been updated using inner loop losses 250 associated with a given support set, meta-training engine 122 performs an “outer loop” that uses representation learning network 216 and prediction learning network 218 to convert examples from the corresponding query set into another set of training output 212. Meta-training engine 122 computes one or more outer loop losses 254 between this set of training output 212 and labels for the examples in the query set. Meta-training engine 122 then uses a training technique (e.g., gradient descent and backpropagation) to update PLN parameters 208 of prediction learning network 218 and/or RLN parameters 206 of representation learning network 216 in a way that reduces outer loop losses 254. Consequently, the “inner loop” optimizes representation learning network 216 and/or prediction learning network 218 on a current set of tasks associated with the support set, and the “outer loop” allows representation learning network 216 and prediction learning network 218 to generalize across multiple tasks and/or remember earlier tasks.

Meta-training engine 122 repeats the process of training representation learning network 216 and prediction learning network 218 using additional support sets 202 and query sets 204 in meta-training data 200. These additional support sets 202 and query sets 204 allow representation learning network 216 and prediction learning network 218 to further adapt to the corresponding tasks without forgetting previously learned tasks.

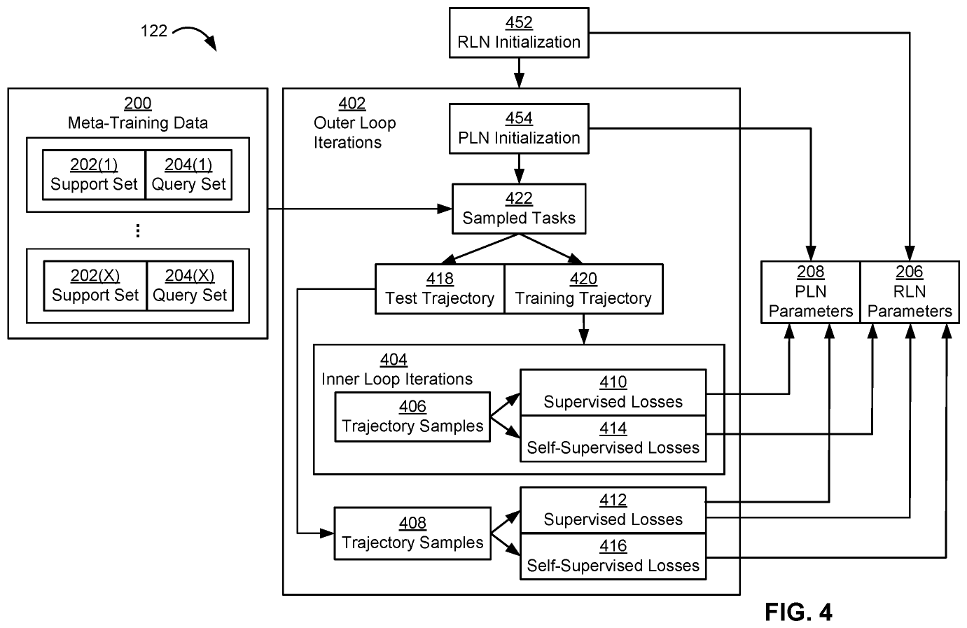

In one or more embodiments, meta-training engine 122 trains representation learning network 216 and/or prediction learning network 218 on one or more self-supervised tasks during “inner loop” and/or “outer loop” optimization of representation learning network 216 and/or prediction learning network 218. For example, meta-training engine 122 could train representation learning network 216 on an infilling task, in which representation learning network 216 learns to reconstruct an image (or another type of data) based on input that includes a subset of regions or patches in the image (or a subset of the other type of data). As described in further detail below with respect to FIG. 4, this self-supervised training improves the ability of representation learning network 216 and/or prediction learning network 218 to learn better representations of the data and adapt to different tasks involving the data.

FIG. 4 illustrates how meta-training engine 122 of FIG. 1 performs meta-training of representation learning network 216 and prediction learning network 218 of FIG. 2, according to various embodiments. As mentioned above, meta-training engine 122 uses meta-training data 200 that includes multiple support sets 202(1)-202(X) and multiple corresponding query sets 204(1)-204(X) to perform meta-training of representation learning network 216 and prediction learning network 218. For example, each support set in meta-training data 200 could include multiple images depicting objects that belong to N different classes, with each class of object represented by K different images. Each support set in meta-training data 200 could also be associated with a corresponding query set that includes images depicting objects that belong to some or all of the N classes in the support set.

Given meta-training data 200 that includes multiple support sets 202(1)-202(X) and multiple corresponding query sets 204(1)-204(X), meta-training engine 122 uses support sets 202(1)-202(X) and query sets 204(1)-204(X) to update RLN parameters 206 of representation learning network 216 and PLN parameters 208 of prediction learning network 218 over a number of outer loop iterations 402 and a number of inner loop iterations 404. More specifically, meta-training engine 122 begins by performing an RLN initialization 452 that randomly initializes RLN parameters 206 of representation learning network 216.

Next, meta-training engine 122 enters outer loop iterations 402. At the beginning of each outer loop iteration, meta-training engine 122 performs a PLN initialization 454 that randomly initializes PLN parameters 208 of prediction learning network 218. Meta-training engine 122 also generates a set of sampled tasks 422 from meta-training data 200. For example, meta-training engine 122 could retrieve the set of sampled tasks 422 as a support set and a corresponding query set in meta-training data 200.

Meta-training engine 122 use sampled tasks 422 to generate a training trajectory 420 and a test trajectory 418. For example, meta-training engine 122 could generate training trajectory 420 as an ordered sequence of labeled samples from the support set. Meta-training engine 122 could also generate test trajectory 418 as an ordered sequence of labeled samples from the query set.

After training trajectory 420 and test trajectory 418 are generated in a given outer loop iteration, meta-training engine 122 performs a series of inner loop iterations 404 that use training trajectory 420 to update PLN parameters 208 of prediction learning network 218 and RLN parameters 206 of representation learning network 216. More specifically, during inner loop iterations 404, meta-training engine 122 inputs images and/or other types of data included in trajectory samples 406 from training trajectory 420 into representation learning network 216 and prediction learning network 218. Meta-training engine 122 computes a set of supervised losses 410 from one set of training output generated by representation learning network 216 and/or prediction learning network 218 from the inputted trajectory samples 406. Meta-training engine 122 also computes a set of self-supervised losses 414 from another set of training output generated by representation learning network 216 and/or prediction learning network 218 from the inputted trajectory samples 406. Meta-training engine 122 could use supervised losses 410 to update PLN parameters 208. Meta-training engine 122 could also use self-supervised losses 414 to update RLN parameters 206. In other words, meta-training engine 122 uses inner loop iterations 404 to train representation learning network 216 and/or prediction learning network 218 on one or more self-supervised learning tasks (e.g., using the corresponding self-supervised losses 414) and one or more supervised learning tasks (e.g., using the corresponding supervised losses 410).

In one or more embodiments, supervised losses 410 are computed using predictions generated by prediction learning network 218 from learned representations 232, which in turn are generated by representation learning network 216 from inputted trajectory samples 406. For example, supervised losses 410 could include one or more cross-entropy losses and/or other measures of error between predictions of classes generated by prediction learning network 218 and labels for the corresponding trajectory samples 406 in training trajectory 420. In another example, supervised losses 410 could include a mean squared error (MSE), mean absolute error (MSE), and/or another measure of error between regression-based predictions generated by prediction learning network 218 and labels for the corresponding trajectory samples 406 in training trajectory 420.

In some embodiments, self-supervised losses 414 are computed between predictions generated by one or more portions of representation learning network 216 from a subset of data in trajectory samples 406, augmented versions of data in trajectory samples 406, and/or other variations of unlabeled portions of data in training trajectory 420. For example, self-supervised training of representation learning network 216 could include training representation learning network 216 on an image infilling task. During this image infilling task, meta-training engine 122 could input a subset of an image (e.g., an image with randomly masked out patches or regions) into an encoder included in representation learning network 216. The encoder could generate a latent representation of the inputted subset of the image, and a decoder included in representation learning network 216 could convert the latent representation into output that corresponds to a reconstruction of the image. Meta-training engine 122 could compute an MSE and/or another type of self-supervised loss between the reconstruction and the original image and use the self-supervised loss to update parameters of the encoder and decoder. As the encoder and decoder are trained using the self-supervised loss, the latent representation generated by the encoder from a given input (or subset of an input image) becomes a learned representation (e.g., in learned representations 232) of visual attributes in the input image.

Additionally, representation learning network 216 and/or prediction learning network 218 can be trained first using self-supervised losses 414 and subsequently using supervised losses 410. For example, meta-training engine 122 could perform a first set of inner loop iterations 404 that train representation learning network 216 on one or more self-supervised tasks using the corresponding self-supervised losses 414. This first set of inner loop iterations 404 allows representation learning network 216 to learn representations of images and/or other types of data involved in the self-supervised task(s). Meta-training engine 122 could then execute a second set of inner loop iterations 404 to train representation learning network 216 and/or prediction learning network 218 on one or more supervised tasks using the corresponding supervised losses 410. Consequently, representations of images and/or other data learned by representation learning network 216 during the first set of inner loop iterations 404 can be applied to the supervised task(s) used to train representation learning network 216 and/or prediction learning network 218 in the second set of inner loop iterations 404.

After inner loop iterations 404 are complete, meta-training engine 122 uses test trajectory 418 to update PLN parameters 208 of prediction learning network 218 and RLN parameters 206 of representation learning network 216. In particular, meta-training engine 122 inputs images and/or other types of data included in trajectory samples 408 from test trajectory 418 into representation learning network 216 and prediction learning network 218. Meta-training engine 122 computes a set of supervised losses 412 from one set of training output generated by representation learning network 216 and/or prediction learning network 218 from the inputted trajectory samples 408. Meta-training engine 122 also computes a set of self-supervised losses 416 from another set of training output generated by representation learning network 216 and/or prediction learning network 218 from the inputted trajectory samples 408.

As with supervised losses 410 computed during inner loop iterations 404, supervised losses 412 can be computed between predictions generated by prediction learning network 218 from learned representations 232 of data from trajectory samples 408 inputted into representation learning network 216. For example, supervised losses 412 could include one or more cross-entropy losses and/or other measures of error between predictions of classes generated by prediction learning network 218 and labels for the corresponding trajectory samples 408 in test trajectory 418. In another example, supervised losses 412 could include a mean squared error (MSE), mean absolute error (MSE), and/or another measure of error between regression-based predictions generated by prediction learning network 218 and labels for the corresponding trajectory samples 408 in test trajectory 418.

Similarly, as with self-supervised losses 414 computed during inner loop iterations 404, self-supervised losses 416 can be computed between predictions generated by one or more portions of representation learning network 216 from a subset of data in trajectory samples 408, augmented versions of data in trajectory samples 408, and/or other variations of unlabeled portions of data in test trajectory 418. For example, self-supervised training of representation learning network 216 could include training representation learning network 216 on an image infilling task using images from test trajectory 418.

Additionally, representation learning network 216 and/or prediction learning network 218 can be trained first using self-supervised losses 416 and subsequently using supervised losses 412. For example, meta-training engine 122 could train representation learning network 216 on one or more self-supervised tasks using the corresponding self-supervised losses 416. Meta-training engine 122 could then train representation learning network 216 and/or prediction learning network 218 on one or more supervised tasks using the corresponding supervised losses 412. Consequently, self-supervised training of representation learning network 216 and/or prediction learning network 218 can be performed before supervised training of representation learning network 216 and/or prediction learning network 218 during both inner loop iterations 404 and outer loop iterations 402.

Meta-training engine 122 can continue executing outer loop iterations 402 and a series of inner loop iterations 404 within each outer loop iteration using additional support sets 202(1)-202(X) and corresponding query sets 204(1)-204(X) from meta-training data 200. For example, meta-training engine 122 can continue updating PLN parameters 208 of prediction learning network 218 and RLN parameters 206 of representation learning network 216 using training trajectories and test trajectories sampled from different support sets 202(1)-202(X) and corresponding query sets 204(1)-204(X) until a certain number (e.g., a prespecified number, a proportion, all, etc.) of support sets 202(1)-202(X) and corresponding query sets 204(1)-204(X) have been used to train prediction learning network 218 and representation learning network 216, a certain number of outer loop iterations 402 have been performed, one or more supervised losses 410 and/or 412 and/or one or more self-supervised losses 414 and/or 416 fall below a threshold, and/or another condition is met.

An example operation of meta-training engine 122 in performing meta-training of prediction learning network 218 and representation learning network 216 can be illustrated using the following steps:

```
Require: p( [symbol]   ): distribution over CLP problemsRequire: α, β: step size hyperparameters
randomly initialize representation learning network θwhile not done do
randomly initialize prediction learning network Wsample CLP problem [symbol]    ᵢ~p( [symbol]   )sample Sₜᵣₐᵢₙ from p(Sₖ|

[symbol]
= Wfor m = 1,2, . . . , k do
    Xₘ, Yₘ = Sₜᵣₐᵢₙ[m]
    Update θ ← θ − α∇_{θ}lₘ(ϕ_{θ}(X′ₘ), Xₘ)
  end for
  for j = 1,2, . . . , k do
    Xⱼ, Yⱼ = Sₜᵣₐᵢₙ[j]
    Wⱼ = Wⱼ₋₁ − α∇_{W}_{_{j−1}}lᵢ(f_{θ,W}_{_{j−1}}(Xⱼ), Yⱼ)
  end for
  Sample Sₜₑₛₜ from p(Sₖ| [symbol]   ᵢ)
  Update θ ← θ − β∇_{θ}lᵢ(ϕ_{θ}(Sₜₑₛₜ[:,0]′),Sₜₑₛₜ[:,0])Update θ
      ← 0 − β∇_{θ}lᵢ(f_{θ,W}_{ₖ} (Sₜₑₛₜ[:,0]),Sₜₑₛₜ[:,1])
end while [symbol]
indicates data missing or illegible when filed
```

In the above pseudocode, meta-training engine 122 operates according to a distribution p( [symbol] ) over continual learning prediction (CLP) problems, where each CLP problem [symbol] =(X₁, Y₁), (X₂, Y₂), . . . , (Xₜ, Yₜ), . . . includes a stream of samples that includes inputs Xₜ from set [symbol] and prediction targets Yₜ from set [symbol] . For example, inputs Xₜ could include images, and prediction targets Yₜ could include classes of objects depicted in the images. Meta-training engine 122 also operates according to hyperparameters α and β, which denote step sizes associated with inner loop iterations 404 and outer loop iterations 402, respectively.

The pseudocode is used to meta-learn a function ϕθ (X): [symbol] → [symbol] ^{d} corresponding to representation learning network 216 parameterized by θ, where d is the dimensionality of the latent space associated with learned representations 232. The pseudocode is also used to meta-learn another function g_{w}: [symbol] _{d}→ [symbol] that corresponds to prediction learning network 218 parameterized by W. These two functions can be composed into a model ƒ_{θ,W}(X)=g_{w}(ϕ_{θ}(X)) for CLP tasks.

The pseudocode begins with RLN initialization 452, which randomly initializes representation learning network 216 ϕ_{θ}(X) by setting RLN parameters 206 θ to random values. After RLN initialization 452 is complete, the pseudocode enters a while loop that performs outer loop iterations 402. At the beginning of each outer loop iteration, the pseudocode performs PLN initialization 454, which initializes prediction learning network 218 g_{w} by setting PLN parameters 208 W to random values.

Next, the pseudocode samples a CLP problem [symbol] ᵢ from the distribution p( [symbol] ). The pseudocode also samples training trajectory 420 Sₜᵣₐᵢₙ from a distribution p(Sₖ| [symbol] ᵢ) of training trajectories of length k that can be sampled from the CLP problem. For example, the pseudocode could sample the CLP problem as a support set and corresponding query set from meta-training data 200. The pseudocode could also sample training trajectory 420 as an ordered sequence of samples from the support set. The pseudocode further copies the randomly initialized PLN parameters 208 to an initial version of prediction learning network 218 denoted by W₀.

The pseudocode then enters a first for loop that includes a first series of inner loop iterations 404 within a given outer loop iteration. During each inner loop iteration in the first for loop, a sample that includes an input Xₘ and a corresponding prediction target Yₘ is retrieved from training trajectory 420 Sₜᵣₐᵢₙ. Representation learning network 216 is trained to learn a self-supervised task that involves augmented input Xₘ′. For example, the self-supervised task could include reconstructing an image Xₘ from input that includes a subset of regions or patches in the image, as denoted by Xₘ′.

After the first for loop is complete, the pseudocode performs a second for loop that includes a second series of inner loop iterations 404 within the same outer loop iteration. During each inner loop iteration of the second for loop, a sample that includes an input Xⱼ and a corresponding prediction target Yⱼ is retrieved from training trajectory 420 Sₜᵣₐᵢₙ. PLN parameters 208 of prediction learning network 218 are trained on a supervised task that involves a comparison of the processing of a given input Xⱼ by representation learning network 216 and prediction learning network 218 and the corresponding prediction target Yⱼ.

After a certain number of inner loop iterations 404 has been performed, the pseudocode resumes the remainder of the outer loop. More specifically, the pseudocode samples test trajectory 418 from the distribution p( [symbol] ). The pseudocode also updates RLN parameters 206 of representation learning network 216 based on a self-supervised task that involves reconstructing inputs in test trajectory 418 denoted by Sₜₑₛₜ[:,0] based on augmented and/or partial representations of the inputs Sₜₑₛₜ[:,0]′. After RLN parameters 206 of representation learning network 216 are updated based on the self-supervised task, RLN parameters 206 of representation learning network 216 and/or PLN parameters 208 of prediction learning network 218 are updated based on a supervised task that involves predicting classes and/or other prediction targets denoted by Sₜₑₛₜ[:,1] in test trajectory 418 based on the corresponding inputs Sₜₑₛₜ[:,0] in test trajectory 418.

The pseudocode completes a given outer loop iteration after RLN parameters 206 and/or PLN parameters 208 have been updated using the test trajectory 418 sampled during the outer loop iteration. The pseudocode can continue performing additional outer loop iterations 402 and a series of inner loop iterations 404 within each outer loop iteration until a certain number of training trajectories and/or test trajectories have been sampled from meta-training data 200, used to train prediction learning network 218 and representation learning network 216, a certain number of outer loop iterations 402 has been performed, one or more supervised losses 410 and/or 412 and/or one or more self-supervised losses 414 and/or 416 fall below a threshold, and/or meta-training of prediction learning network 218 and representation learning network 216 is otherwise determined to be complete.

While self-supervised losses 414 and 416 are described above with an image infilling task, it will be appreciated that representation learning network 216 and/or prediction learning network 218 can be trained using a variety of self-supervised tasks and/or different self-supervised losses. For example, representation learning network 216 could be trained on a self-supervised task that involves predicting masked out words in a sequence of text. In another example, different augmented views of the same data sample could be inputted into representation learning network 216, and representation learning network 216 could be trained to output similar latent representations for these augmented views. In a third example, representation learning network 216 could be trained to predict rotations, clusters, orderings of patches within images or words in text, optical flow, and/or other types of augmentations or properties of augmented data samples.

Returning to the discussion of FIG. 2, after meta-training of representation learning network 216 and prediction learning network 218 is complete, meta-testing engine 122 uses a set of meta-testing data 220 to perform meta-testing of representation learning network 216 and prediction learning network 218. As with meta-training data 200, meta-testing data 220 includes one or more support sets 222 and one or more query sets 224. Each support set in meta-testing data 220 includes labeled samples that are from classes and/or otherwise represent tasks that have not been used in meta-training of representation learning network 216 and prediction learning network 218. For example, each support set could include K labelled samples for each of N new classes. Each support set is paired with a query set (e.g., in query sets 224) of additional labeled samples from the same classes. The query set could also, or instead, include additional labeled samples from classes or tasks associated with earlier support sets 202 (e.g., classes or tasks that have already been used to train representation learning network 216 and prediction learning network 218).

During meta-testing of representation learning network 216 and prediction learning network 218, meta-testing engine 124 trains prediction learning network 218 using a sequence of support sets 222 and corresponding query sets 224 from meta-testing data 220. More specifically, meta-testing engine 124 performs an “inner loop” that uses representation learning network 216 and prediction learning network 218 to convert samples from a given support set into corresponding support set output 234. Meta-testing engine 124 computes one or more inner loop losses 252 (e.g., supervised losses) between support set output 234 and labels for the samples in the support set. Meta-testing engine 124 then uses a training technique (e.g., gradient descent and backpropagation) to update PLN parameters 208 of prediction learning network 218 in a way that reduces inner loop losses 252.

After PLN parameters 208 have been updated using inner loop losses 252 associated with a given support set, meta-testing engine 124 performs an “outer loop” that uses representation learning network 216 and prediction learning network 218 to convert samples from the corresponding query set into query set output 236. Meta-testing engine 124 uses query set output 236 and labels for the samples in the query set to determine a performance 256 of representation learning network 216 and prediction learning network 218 in performing one or more tasks associated with the query set. For example, meta-testing engine 124 could use inner loop losses 252 to train prediction learning network 218 to predict labels for new classes of objects depicted in a small set of images from the support set. Then, without further training representation learning network 216 on samples of the new classes, meta-testing engine 124 could compute one or more metrics used to evaluate performance 256 of representation learning network 216 and prediction learning network 218 on predicting the new classes from additional images in the query set.

Consequently, meta-testing engine 124 can test performance 256 of representation learning network 216 and prediction learning network 218 on predicting new classes using knowledge acquired by representation learning network 216 while learning older classes (e.g., during meta-training). Meta-testing engine 124 can repeat the process using additional support sets 202 and query sets 204 of new classes to further evaluate the ability of representation learning network 216 and prediction learning network 218 to adapt to more tasks while relying on knowledge used to distinguish the older classes.

While the operation of meta-training engine 122 and meta-testing engine 124 has been described above with respect to training prediction learning network 218 using support sets 202 and 222 and the corresponding inner loop losses 250 and 252 and training representation learning network 216 and prediction learning network 218 using query sets 204 and the corresponding outer loop losses 254, it will be appreciated that meta-training and/or meta-testing of representation learning network 216 and prediction learning network 218 can be performed in a variety of ways. For example, meta-training engine 122 could update both RLN parameters 206 and PLN parameters 208 using some or all inner loop losses 250 within each iteration of the same inner loop. Meta-testing engine 124 could also, or instead, update both RLN parameters 206 and PLN parameters 208 using some or all inner loop losses 252 associated with a given support set in meta-testing data 220 before evaluating performance 256 on a corresponding query set in meta-testing data 220.

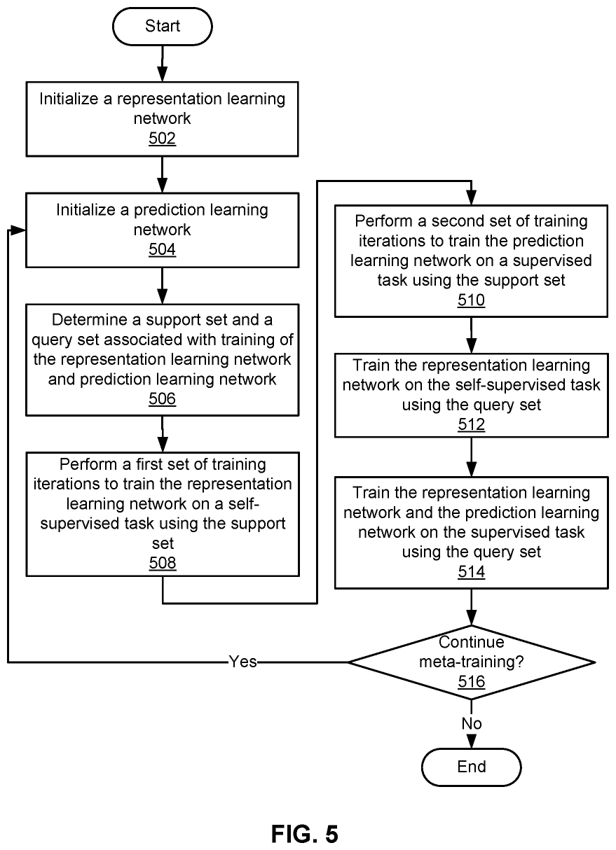

FIG. 5 sets forth a flow diagram of method steps for performing meta-learning, according to various embodiments. Although the method steps are described in conjunction with the systems of FIGS. 1-2, persons skilled in the art will understand that any system configured to perform the method steps in any order falls within the scope of the present disclosure.

As shown, in step 502, meta-training engine 122 initializes a representation learning network. In step 504, meta-training engine 122 initializes a prediction learning network. For example, meta-training engine 122 could initialize weights in the representation learning network and prediction learning network to random values.

In step 506, meta-training engine 122 determines a support set and a query set associated with training of the representation learning network and prediction learning network. For example, meta-training engine 122 could retrieve the support set and query set from a set of meta-training data. The support set could include K labelled samples for each of N classes (e.g., K images of each of N different objects). The query set could include additional labeled examples from the same classes as those included in the support set.

In step 508, meta-training engine 122 performs a first set of training iterations to train the representation learning network on a self-supervised task using the support set. For example, meta-training engine 122 could execute a first for loop that includes the first set of training iterations. During each iteration in the first for loop, meta-training engine 122 could retrieve a data sample (e.g., an image) from the support set. Meta-training engine 122 could generate an augmented version of the sample by masking or removing a subset of the data sample (e.g., one or more regions or patches in the image) and/or applying one or more transformations to the sample (e.g., random resizing, cropping, color jitter, brightness alterations, and/or other image transformations to the image). Meta-training engine 122 could input the augmented version of the data sample into an encoder included in the representation learning network. The encoder could generate a latent representation of the inputted subset of the image, and a decoder included in the representation learning network could convert the latent representation into self-supervised training output that corresponds to a reconstruction of the image. Meta-training engine 122 could update parameters of the representation learning network using an MSE and/or another type of self-supervised loss between the original sample and the reconstruction of the sample generated by the representation learning network from the augmented version of the sample.

In step 510, meta-training engine 122 performs a second set of training iterations to train the prediction learning network on a supervised task using the support set. For example, meta-training engine 122 could execute a second for loop that includes the second set of training iterations. During each iteration in the second for loop, meta-training engine 122 could retrieve a sample (e.g., an image) from the support set. Meta-training engine 122 could use the representation learning network to convert the sample into a latent representation. Meta-training engine 122 could also use the prediction learning network to convert the latent representation into a prediction of a class and/or another type of supervised output for the sample. Meta-training engine 122 could then update parameters of the prediction learning network using a cross-entropy loss and/or another type of supervised loss between the prediction generated by the prediction learning network and the label for the sample.

In step 512, meta-training engine 122 trains the representation learning network on the self-supervised task using the query set. For example, meta-training engine 122 could generate augmented versions of samples in the query set. Meta-training engine 122 could use the representation learning network to convert the augmented versions into self-supervised training output that includes reconstructions of the corresponding samples. Meta-training engine 122 could also update parameters of the representation learning network using an MSE and/or another type of self-supervised loss between the original samples and the reconstructions generated by the representation learning network from the augmented versions of the samples.

In step 514, meta-training engine 122 trains the representation learning network and the prediction learning network on the supervised task using the query set. For example, meta-training engine 122 could use the representation learning network to convert samples from the query set into latent representations. Meta-training engine 122 could also use the prediction learning network to convert the latent representations into predictions of classes and/or another type of supervised output for the corresponding samples. Meta-training engine 122 could then update parameters of the representation learning network and prediction learning network using a cross-entropy loss and/or another type of supervised loss between the predictions generated by the prediction learning network and the labels for the corresponding samples.

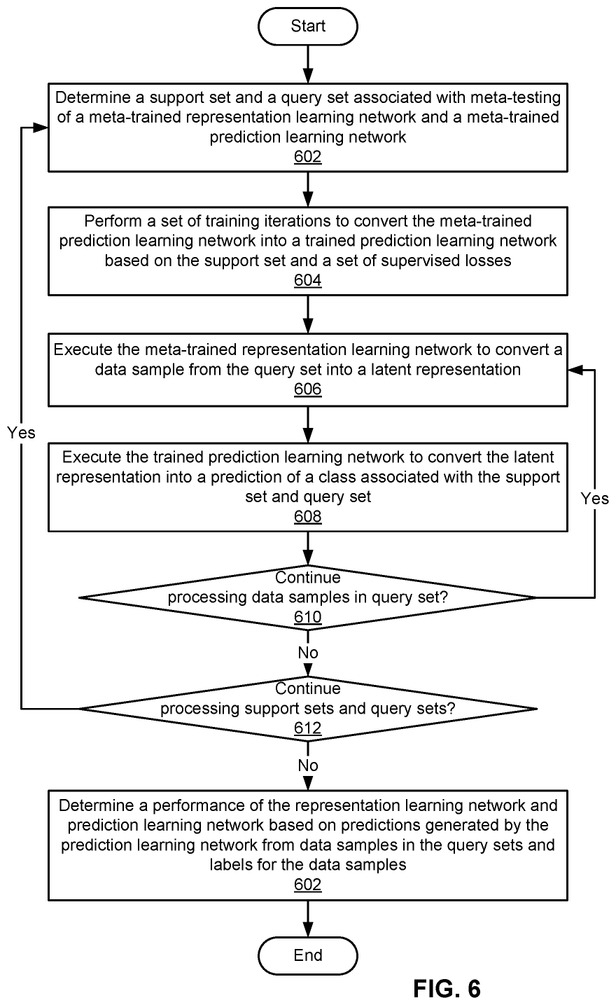

In step 516, meta-training engine 122 determines whether or not to continue meta-training of the representation learning network and prediction learning network. For example, meta-training engine 122 could continue meta-training of the representation learning network and prediction learning network until the prediction learning network and representation learning network have been trained using a certain number of support sets and/or query sets, one or more supervised losses and/or self-supervised losses fall below a threshold, and/or meta-training of the prediction learning network and representation learning network is otherwise determined to be complete. While meta-training engine 122 determines that meta-training of the representation learning network and prediction learning network is to continue, meta-training engine 122 repeats steps 504, 506, 508, 510, 512, and 514 to continue training the representation learning network and prediction learning network on the self-supervised and supervised tasks using different support and query sets. After meta-training engine 122 determines that meta-training of the representation learning network and prediction learning network is complete, meta-testing engine 124 can perform meta-testing of the meta-trained representation learning network and prediction learning network using additional support sets and query sets, as discussed in further detail below with respect to FIG. 6.

FIG. 6 sets forth a flow diagram of method steps for performing meta-testing of a machine learning model, according to various embodiments. Although the method steps are described in conjunction with the systems of FIGS. 1-2, persons skilled in the art will understand that any system configured to perform the method steps in any order falls within the scope of the present disclosure.

As shown, in step 602, meta-testing engine 124 determines a support set and a query set associated with meta-testing of a meta-trained representation learning network and a meta-trained prediction learning network. For example, meta-testing engine 124 could retrieve the support set and query set from a set of meta-testing data after meta-training of the representation learning network and prediction learning network is complete. The support set could include K labelled samples for each of N classes (e.g., K images of each of N different objects). The query set could include additional labeled examples from the same classes as those included in the support set. Classes associated with the support set and query set could additionally be distinct from classes used to perform meta-training of the representation learning network and prediction learning network.

In step 604, meta-testing engine 124 performs a set of training iterations to convert the meta-trained prediction learning network into a trained prediction network based on the support set and a set of supervised losses. For example, meta-testing engine 124 could execute a for loop that includes the set of training iterations. During each iteration in the second for loop, meta-testing engine 124 could retrieve a sample (e.g., an image) from the support set. Meta-testing engine 124 could use the representation learning network to convert the sample into a latent representation. Meta-testing engine 124 could also use the prediction learning network to convert the latent representation into a prediction of a class and/or another type of supervised output for the sample. Meta-testing engine 124 could then update parameters of the representation learning network using a cross-entropy loss and/or another type of supervised loss between the prediction generated by the prediction learning network and the label for the sample.

In step 606, meta-testing engine 124 executes the meta-trained representation learning network to convert a data sample from the query set into a latent representation. For example, meta-testing engine 124 could use an encoder included in the representation learning network to convert an image and/or another type of data included in the data sample into the latent representation.

In step 608, meta-testing engine 124 executes the trained prediction learning network to convert the latent representation into a prediction of a class associated with the support set and query set. For example, meta-testing engine 124 could use a set of fully connected layers and/or other types of neural network layers in the trained prediction learning network to convert the latent representation into scores representing probabilities of classes associated with the support set and query set.

In step 610, meta-testing engine 124 determines whether or not to continue processing data samples in the query set. For example, meta-testing engine 124 could determine that processing of data samples in the query set is to continue if the query set includes additional data samples that have not been processed by the meta-trained representation learning network and the trained prediction learning network. While meta-testing engine 124 determines that processing of data samples in the query set is to continue, meta-testing engine 124 repeats steps 606 and 608 to generate predictions of classes for the additional data samples using the meta-trained representation learning network and the trained prediction learning network.

After meta-testing engine 124 determines that processing of data samples in the query set is to be discontinued, meta-testing engine 124 performs step 610, in which meta-testing engine 124 determines whether or not to continue processing support sets and query sets. For example, meta-testing engine 124 could determine that processing of support sets and query sets is to continue if meta-testing data for the representation learning network and prediction learning network includes additional support sets and query sets. While meta-testing engine 124 determines that processing of support sets and query sets is to continue, meta-testing engine 124 repeats steps 602 and 604 to train the prediction learning network on supervised (e.g., classification) tasks associated with the support sets. Meta-testing engine 124 also repeats steps 606, 608, and 610 to use the trained prediction learning network and meta-trained representation learning network to generate predictions of classes for the data samples in the corresponding query sets.

After meta-testing engine 124 determines that processing of support sets and query sets is to be discontinued, meta-testing engine 124 performs step 612, in which meta-testing engine 124 determines a performance of the representation learning network and prediction learning network based on predictions generated by the prediction learning network from data samples in the query sets and labels for the data samples. For example, meta-testing engine 124 could compute an accuracy, confusion matrix, precision, recall, F1 score, area under the curve receiver operating characteristics (AUC-ROC), cross-entropy loss, and/or another performance metric from the predictions and the corresponding labels. Meta-training engine 122 and/or meta-testing engine 124 could also use the determined performance to perform additional training, testing, meta-training, and/or meta-testing of the representation learning network and prediction learning network; compare the performance of multiple versions of the representation learning network and prediction learning network; compare various meta-training and/or meta-testing strategies associated with the representation learning network and prediction learning network; determine additional techniques for meta-training and/or meta-testing of the representation learning network and prediction learning network; and/or perform other actions related to evaluating and/or improving the performance of the representation learning network and prediction learning network.

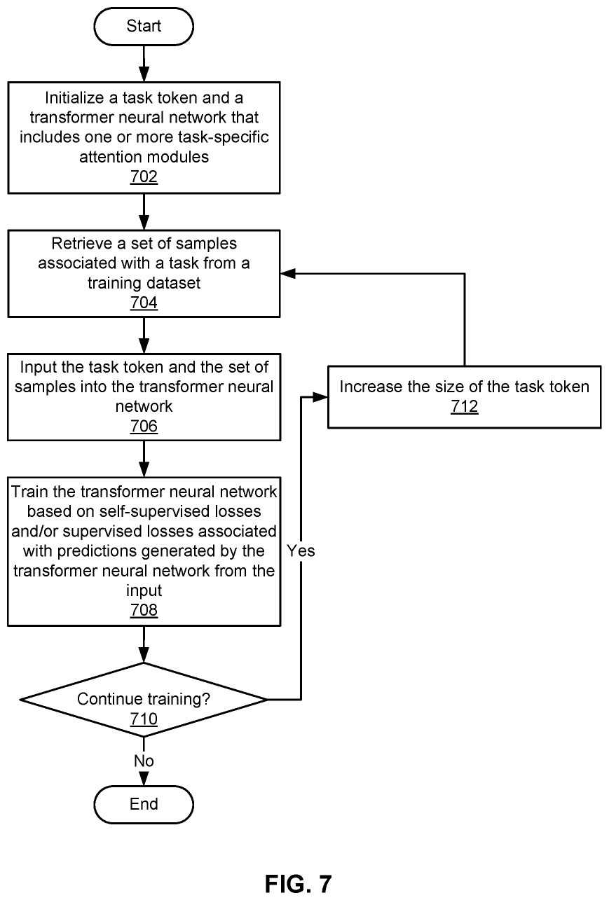

FIG. 7 sets forth a flow diagram of method steps for training a transformer neural network, according to various embodiments. Although the method steps are described in conjunction with the systems of FIGS. 1-2, persons skilled in the art will understand that any system configured to perform the method steps in any order falls within the scope of the present disclosure.

As shown, in step 702, meta-training engine 122 initializes a task token and a transformer neural network that includes one or more task-specific attention modules. For example, meta-training engine 122 could initialize the task token as a vector of a certain length and randomized values. Meta-training engine 122 could also initialize the transformer neural network to include an encoder and/or decoder with randomized weights. Each of the encoder and/or decoder could include a series of transformer blocks, so that the output of one transformer block is used as input into the next transformer block. Each transformer block could include a task-specific attention module and/or other neural network components (e.g., one or more normalization layers, linear layers, feedforward layers, multilayer perceptrons, etc.). The transformer neural network could be included in a representation learning network and/or another type of continual learning and/or meta-learning model.

In step 704, meta-training engine 122 retrieves a set of samples associated with a task from a training dataset. For example, meta-training engine 122 could retrieve the set of samples from a support set, query set, and/or another set of training data. The set of samples could be labeled with one or more classes that represent the task.

In step 706, meta-training engine 122 inputs the task token and the set of samples into the transformer neural network. For example, meta-training engine 122 could use a first attention unit to process a set of input tokens representing each sample. Meta-training engine 122 could execute the first attention unit to convert the input tokens into a first query, a first key, and multiple values, compute a first set of attention scores from the first query and first key, and combine the values with the first set of attention scores into multiple outputs. Meta-training engine 122 could also input a concatenation of the task token and the input tokens into a second attention unit. Meta-training engine 122 could use the second attention unit to convert the concatenated input into a second query, a second key, and a single value, compute a second set of attention scores from the second query and second key, and combine the single value with the second set of attention scores into an output that is used to generate an output task token. Meta-training engine 122 could then scale the multiple outputs from the first attention unit using multiple corresponding weights to compute multiple keys, combine the multiple keys with the task token into multiple scores, and compute a final output as a sum of the multiple outputs from the first attention unit scaled by the corresponding scores.

In step 708, meta-training engine 122 trains the transformer neural network based on self-supervised losses and/or supervised losses associated with predictions generated by the transformer neural network from the input. For example, meta-training engine 122 could use one or more inner loops and an outer loop to train a representation learning network that includes the transformer neural network and/or a prediction learning network that operates on the output of the representation learning network using the losses, as described above with respect to FIG. 5. In another example, meta-training engine 122 could train the transformer neural network using various continual learning and/or meta-learning paradigms.

In step 710, meta-training engine 122 determines whether or not to continue training the transformer neural network. For example, meta-training engine 122 could determine that training of the transformer neural network is to continue until the transformer neural network has been trained on all tasks, one or more supervised losses and/or self-supervised losses fall below a threshold, and/or training of the transformer neural network is otherwise determined to be complete.

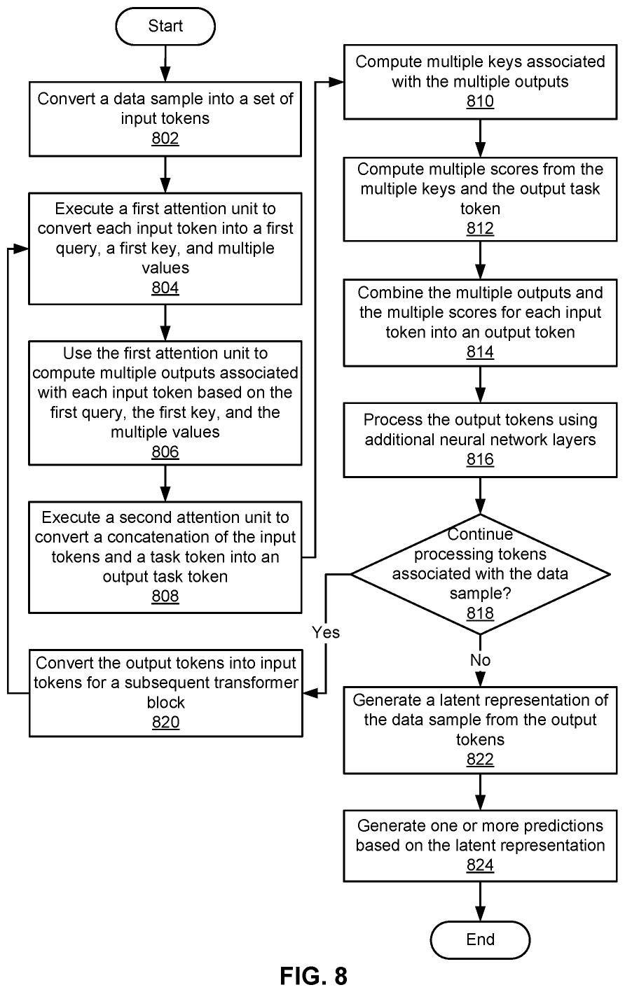

When meta-training engine 122 determines that training of the transformer neural network is to continue, meta-training engine 122 performs step 712, in which meta-training engine 122 increases the size of the task token. For example, meta-training engine 122 could add one or more randomly initialized elements to the end of the vector corresponding to the task token. Meta-training engine 122 then repeats steps 704, 706, 708, and 710 to continue training the transformer neural network using different sets of samples from the training dataset and/or on different tasks associated with the sets of samples. After meta-training engine 122 determines that training of the transformer neural network is complete, meta-testing engine 124 can perform meta-testing, testing, and/or inference using the trained transformer neural network, as described in further detail below with respect to FIG. 8.

FIG. 8 sets forth a flow diagram of method steps for executing a transformer neural network, according to various embodiments. Although the method steps are described in conjunction with the systems of FIGS. 1-2, persons skilled in the art will understand that any system configured to perform the method steps in any order falls within the scope of the present disclosure.

As shown, in step 802, meta-testing engine 124 converts a data sample into a set of input tokens. For example, meta-testing engine 124 could divide an image into multiple contiguous patches and use an embedding layer to convert each patch into a corresponding input token. In another example, meta-testing engine 124 could divide a sequence of text into words and use an embedding layer to convert each word into a corresponding input token.

In step 804, meta-testing engine 124 executes a first attention unit to convert each input token into a first query, a first key, and multiple values. For example, meta-testing engine 124 could use multiple sets of weights to convert a concatenation of the input tokens into corresponding queries, keys, and multiple sets of values.

In step 806, meta-testing engine 124 uses the first attention unit to compute multiple outputs associated with each input token based on the first query, the first key, and the multiple values. For example, meta-testing engine 124 could use a matrix multiplication layer, a scaling layer, and/or another layer to compute a scaled cosine similarity between the first query and the first key. Meta-testing engine 124 could also use a softmax layer to convert the scaled cosine similarity into a first set of attention scores associated with each input token. Meta-testing engine 124 could then combine the first set of attention scores and the multiple values into multiple outputs for each input token.

In step 808, meta-testing engine 124 executes a second attention unit to convert a concatenation of the input tokens and a task token into an output task token. For example, meta-testing engine 124 could combine the concatenated input with additional sets of weights into a second query, a second key, and a single value. Meta-testing engine 124 could use one or more layers to convert the second query and second key into a second set of attention scores. Meta-testing engine 124 could then combine the second set of attention scores and the value into an output and obtain the output task token as a portion (e.g., one or more rows) of the output.

In step 810, meta-testing engine 124 computes multiple keys associated with the multiple outputs. For example, meta-testing engine 124 could scale the multiple outputs using a third set of weights to produce the multiple keys.

In step 812, meta-testing engine 124 computes multiple scores from the multiple keys and the output task token. For example, meta-testing engine 124 could generate the scores by performing matrix multiplications of the keys and output task token.

In step 814, meta-testing engine 124 combines the multiple outputs and the multiple scores for each input token into an output token. For example, meta-testing engine could use the scores as mask values that are used to scale and/or select a subset of the outputs for use in computing the output token. The output token could thus be computed as a weighted sum of the outputs, where each output is multiplied by a corresponding score ranging between 0 and 1.

In step 816, meta-testing engine 124 processes the output token using additional neural network layers. For example, meta-testing engine 124 could update the task token using normalization, fully connected, and/or other types of neural network layers.

In step 818, meta-testing engine 124 determines whether or not to continue processing tokens associated with the data sample. For example, meta-testing engine 124 could determine that processing of tokens associated with the data sample is to continue while the tokens have not been processed by all transformer blocks in the transformer neural network.

If meta-testing engine 124 determines that processing of tokens associated with the data sample is to continue, meta-testing engine 124 performs step 820, in which meta-testing engine converts the output tokens into input tokens for a subsequent transformer block in the transformer neural network. For example, meta-testing engine 124 could concatenate the output tokens into a matrix of input tokens for the next transformer block. Meta-testing engine 124 then repeats steps 804, 806, 808, 810, 812, 814, 816, and 818 to process the input tokens using attention units and/or other layers in the next transformer block.

Once meta-testing engine 124 determines that processing of tokens is not to continue, meta-testing engine 124 performs step 822, in which meta-testing engine 124 generates a latent representation of the data sample from the output tokens. For example, meta-testing engine 124 could concatenate and/or aggregate the output tokens into the latent representation, use one or more additional neural network layers to convert the output tokens into the latent representation, and/or otherwise transform the output tokens into the latent representation.

In step 824, meta-testing engine 124 generates one or more predictions based on the latent representation. For example, meta-testing engine 124 could use a prediction learning network to convert the latent representation into a prediction of a class for the data sample. Meta-testing engine 124 could also, or instead, use a decoder to convert the latent representation into generative output associated with the data sample. This generative output could include (but is not limited to) denoising, sharpening, blurring, colorization, compositing, super-resolution, image-to-image translation, inpainting, and/or outpainting of the data sample.

In sum, the disclosed techniques can be used to improve the performance of machine learning models in learning sequences of tasks and/or learning to perform new tasks with few training samples. First, the disclosed techniques provide a task-specific sparse attention module that can be used in a neural network with a transformer architecture. The task-specific sparse attention module encodes an input token into a query, a key, and multiple values. The values are used to compartmentalize the task-specific sparse attention module into distinct sub-units that are selectively activated to perform different tasks. The values are scaled using attention scores computed between pairs of input tokens to generate multiple corresponding outputs. A task token that encodes different sets of tasks is combined with the input tokens and used to generate an output task token. The output task token is used to determine scores representing the relative importances of the sub-units to the task associated with the input. These scores are additionally combined with the outputs into a final output for the input token, thereby allowing different tasks to be performed using different combinations of sub-units within the task-specific sparse attention module.

The disclosed techniques additionally provide a training technique that can be used with the task-specific attention module and/or other types of neural network architectures or components. The training technique includes one or more inner loops that introduce tasks to the machine learning model in a sequential manner and an outer loop that performs optimization between a current task and previous tasks to allow the machine learning model to remember earlier tasks. Both types of loops can involve training the machine learning model to learn representations of different types of images (or other types of data) by having the model perform a self-supervised learning task, such as filling in missing patches or portions of the data.

One technical advantage of the disclosed techniques relative to the prior art is that the disclosed techniques enable a machine learning model to adapt more readily to a new task by better leveraging the knowledge gained when previously trained for some other task. Consequently, with the disclosed techniques, a machine learning model can be trained to perform each new task more quickly and/or using fewer samples per task than conventional approaches that involve using large sets of training data and many training iterations to train a machine learning model to perform each task. Further, with the disclosed techniques, a machine learning model is able to adapt continually to new tasks without substantially overwriting the ability of the machine learning model to perform previously learned tasks. Accordingly, machine learning models trained using the disclosed techniques can perform more tasks and perform individual tasks more accurately than conventional machine learning models that oftentimes exhibit catastrophic forgetting of previously learned tasks after being subsequently trained for new tasks. The disclosed techniques are especially useful with machine learning models trained under few-shot training paradigms, where catastrophic forgetting is particularly prominent. These technical advantages provide one or more technological improvements over prior art approaches.

1. In some embodiments, a computer-implemented method for training a transformer neural network comprises inputting a first task token and a first set of samples included in a training dataset into the transformer neural network; training the transformer neural network based on a first set of losses computed between a first set of predictions generated by the transformer neural network from the first task token and the first set of samples as well as a first set of labels for the first set of samples; converting the first task token into a second task token that is larger than the first task token; inputting the second task token and a second set of samples included in the training dataset into the transformer neural network; and performing a plurality of training operations on the transformer neural network based on a second set of losses computed between a second set of predictions generated by the transformer neural network from the second task token and the second set of samples as well as a second set of labels for the second set of samples, wherein, once trained, the transformer neural network generates a third task token from at least a portion of a data sample and performs a task associated with the data sample based on the third task token.

2. The computer-implemented method of clause 1, further comprising converting the second task token into a fourth task token that is larger than the second task token; and performing a plurality of training operations on the transformer neural network based on the fourth task token and a third set of losses associated with a third set of samples inputted into the transformer neural network.

3. The computer-implemented method of any of clauses 1-2, wherein inputting the first task token and the first set of samples into the transformer neural network comprises converting a sample included in the first set of samples into a plurality of input tokens; and inputting the plurality of input tokens into a first attention unit included in the transformer neural network, wherein the first attention unit converts each input token included in the plurality of input tokens into a first query, a first key, and a plurality of values.

4. The computer-implemented method of any of clauses 1-3, wherein inputting the first task token and the first set of samples into the transformer neural network further comprises inputting the first task token and the plurality of input tokens into a second attention unit included in the transformer neural network, wherein the second attention unit converts the first task token and the plurality of input tokens into a second query, a second key, and a value.

5. The computer-implemented method of any of clauses 1-4, further comprising executing a first portion of the transformer neural network to compute a plurality of outputs based on the first query, the first key, and the plurality of values, and executing a second portion of the transformer neural network to compute an output token based on a combination of the plurality of outputs with a plurality of scores.

6. The computer-implemented method of any of clauses 1-5, further comprising performing a plurality of training operations on the transformer neural network based on a third set of losses computed between the first set of samples and a third set of predictions generated by the transformer neural network from the first task token and augmented versions of the first set of samples.

7. The computer-implemented method of any of clauses 1-6, further comprising generating the augmented versions of the first set of samples by removing one or more portions of the first set of samples.

8. The computer-implemented method of any of clauses 1-7, wherein converting the first task token into the second task token comprises increasing a size of the first task token.

9. The computer-implemented method of any of clauses 1-8, wherein the first set of samples corresponds to a first support set of training data, and the second set of samples corresponds to a second support set of training data.

10. The computer-implemented method of any of clauses 1-9, wherein the first set of predictions comprises a set of classes associated with the first set of samples.

11. In some embodiments, one or more non-transitory computer-readable media store instructions that, when executed by one or more processors, cause the one or more processors to perform the steps of inputting a first task token and a first set of samples included in a training dataset into a transformer neural network; training the transformer neural network based on a first set of losses computed between a first set of predictions generated by the transformer neural network from the first task token and the first set of samples as well as a first set of labels for the first set of samples; converting the first task token into a second task token that is larger than the first task token; inputting the second task token and a second set of samples included in the training dataset into the transformer neural network; and training the transformer neural network based on a second set of losses computed between a second set of predictions generated by the transformer neural network from the second task token and the second set of samples as well as a second set of labels for the second set of samples, wherein, once trained, the transformer neural network generates a third task token from at least a portion of a data sample and performs a task associated with the data sample based on the third task token.

12. The one or more non-transitory computer-readable media of clause 11, wherein the instructions further cause the one or more processors to perform the steps of converting the second task token into a fourth task token that is larger than the second task token; and training the transformer neural network based on the fourth task token and a third set of losses associated with a third set of samples inputted into the transformer neural network.

13. The one or more non-transitory computer-readable media of any of clauses 11-12, wherein inputting the first task token and the first set of samples into the transformer neural network comprises converting a sample included in the first set of samples into a plurality of input tokens; inputting the plurality of input tokens into a first attention unit included in the transformer neural network; and inputting the first task token and the plurality of input tokens into a second attention unit included in the transformer neural network.

14. The one or more non-transitory computer-readable media of any of clauses 11-13, wherein the first attention unit converts each input token included in the plurality of input tokens into a first query, a first key, and a plurality of values.

15. The one or more non-transitory computer-readable media of any of clauses 11-14, wherein the second attention unit converts the first task token and the plurality of input tokens into a fourth task token.

16. The one or more non-transitory computer-readable media of any of clauses 11-15, wherein the transformer neural network generates the first set of predictions based on a plurality of outputs generated by the first attention unit and a plurality of scores associated with a fourth task token generated by the second attention unit.

17. The one or more non-transitory computer-readable media of any of clauses 11-16, wherein the instructions further cause the one or more processors to perform the step of performing one or more training operations on the transformer neural network based on a set of self-supervised losses computed between the first set of samples and a third set of predictions generated by the transformer neural network from the first task token and augmented versions of the first set of samples.

18. The one or more non-transitory computer-readable media of any of clauses 11-17, wherein the first set of labels is associated with a first set of classes and the second set of labels is associated with a second set of classes that is different from the first set of classes.

19. The one or more non-transitory computer-readable media of any of clauses 11-18, wherein converting the first task token into the second task token comprises adding one or more elements to a vector corresponding to the first task token.

20. In some embodiments, a system comprises one or more memories that store instructions, and one or more processors that are coupled to the one or more memories and, when executing the instructions, are configured to perform the steps of inputting a first task token and a first set of samples included in a training dataset into a transformer neural network; training the transformer neural network based on a first set of losses computed between a first set of outputs generated by the transformer neural network from the first task token and the first set of samples as well as a first set of labels for the first set of samples; converting the first task token into a second task token that is larger than the first task token; inputting the second task token and a second set of samples included in the training dataset into the transformer neural network; and training the transformer neural network based on a second set of losses computed between a second set of outputs generated by the transformer neural network from the second task token and the second set of samples as well as a second set of labels for the second set of samples, wherein, once trained, the transformer neural network generates a third task token from at least a portion of a data sample and performs a task associated with the data sample based on the third task token.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a transformer neural network, the method comprising:
inputting a first task token and a first set of samples included in a training dataset into the transformer neural network;
training the transformer neural network based on a first set of losses computed between a first set of predictions generated by the transformer neural network from the first task token and the first set of samples as well as a first set of labels for the first set of samples;
converting the first task token into a second task token that is larger than the first task token;
inputting the second task token and a second set of samples included in the training dataset into the transformer neural network; and
performing a plurality of training operations on the transformer neural network based on a second set of losses computed between a second set of predictions generated by the transformer neural network from the second task token and the second set of samples as well as a second set of labels for the second set of samples, wherein, once trained, the transformer neural network generates a third task token from at least a portion of a data sample and performs a task associated with the data sample based on the third task token.

2. The computer-implemented method of claim 1, further comprising:
converting the second task token into a fourth task token that is larger than the second task token; and
performing a plurality of training operations on the transformer neural network based on the fourth task token and a third set of losses associated with a third set of samples inputted into the transformer neural network.

3. The computer-implemented method of claim 1, wherein inputting the first task token and the first set of samples into the transformer neural network comprises:
converting a sample included in the first set of samples into a plurality of input tokens; and
inputting the plurality of input tokens into a first attention unit included in the transformer neural network, wherein the first attention unit converts each input token included in the plurality of input tokens into a first query, a first key, and a plurality of values.

4. The computer-implemented method of claim 3, wherein inputting the first task token and the first set of samples into the transformer neural network further comprises inputting the first task token and the plurality of input tokens into a second attention unit included in the transformer neural network, wherein the second attention unit converts the first task token and the plurality of input tokens into a second query, a second key, and a value.

5. The computer-implemented method of claim 3, further comprising:
executing a first portion of the transformer neural network to compute a plurality of outputs based on the first query, the first key, and the plurality of values,
and
executing a second portion of the transformer neural network to compute an output token based on a combination of the plurality of outputs with a plurality of scores.

6. The computer-implemented method of claim 1, further comprising performing a plurality of training operations on the transformer neural network based on a third set of losses computed between the first set of samples and a third set of predictions generated by the transformer neural network from the first task token and augmented versions of the first set of samples.

7. The computer-implemented method of claim 6, further comprising generating the augmented versions of the first set of samples by removing one or more portions of the first set of samples.

8. The computer-implemented method of claim 1, wherein converting the first task token into the second task token comprises increasing a size of the first task token.

9. The computer-implemented method of claim 1, wherein the first set of samples corresponds to a first support set of training data, and the second set of samples corresponds to a second support set of training data.

10. The computer-implemented method of claim 1, wherein the first set of predictions comprises a set of classes associated with the first set of samples.

11. One or more non-transitory computer-readable media storing instructions that, when executed by one or more processors, cause the one or more processors to perform the steps of:
inputting a first task token and a first set of samples included in a training dataset into a transformer neural network;
training the transformer neural network based on a first set of losses computed between a first set of predictions generated by the transformer neural network from the first task token and the first set of samples as well as a first set of labels for the first set of samples;
converting the first task token into a second task token that is larger than the first task token;
inputting the second task token and a second set of samples included in the training dataset into the transformer neural network; and
training the transformer neural network based on a second set of losses computed between a second set of predictions generated by the transformer neural network from the second task token and the second set of samples as well as a second set of labels for the second set of samples, wherein, once trained, the transformer neural network generates a third task token from at least a portion of a data sample and performs a task associated with the data sample based on the third task token.

12. The one or more non-transitory computer-readable media of claim 11, wherein the instructions further cause the one or more processors to perform the steps of:
converting the second task token into a fourth task token that is larger than the second task token; and
training the transformer neural network based on the fourth task token and a third set of losses associated with a third set of samples inputted into the transformer neural network.

13. The one or more non-transitory computer-readable media of claim 11, wherein inputting the first task token and the first set of samples into the transformer neural network comprises:
converting a sample included in the first set of samples into a plurality of input tokens;
inputting the plurality of input tokens into a first attention unit included in the transformer neural network; and
inputting the first task token and the plurality of input tokens into a second attention unit included in the transformer neural network.

14. The one or more non-transitory computer-readable media of claim 13, wherein the first attention unit converts each input token included in the plurality of input tokens into a first query, a first key, and a plurality of values.

15. The one or more non-transitory computer-readable media of claim 13, wherein the second attention unit converts the first task token and the plurality of input tokens into a fourth task token.

16. The one or more non-transitory computer-readable media of claim 13, wherein the transformer neural network generates the first set of predictions based on a plurality of outputs generated by the first attention unit and a plurality of scores associated with a fourth task token generated by the second attention unit.

17. The one or more non-transitory computer-readable media of claim 11, wherein the instructions further cause the one or more processors to perform the step of performing one or more training operations on the transformer neural network based on a set of self-supervised losses computed between the first set of samples and a third set of predictions generated by the transformer neural network from the first task token and augmented versions of the first set of samples.

18. The one or more non-transitory computer-readable media of claim 11, wherein the first set of labels is associated with a first set of classes and the second set of labels is associated with a second set of classes that is different from the first set of classes.

19. The one or more non-transitory computer-readable media of claim 11, wherein converting the first task token into the second task token comprises adding one or more elements to a vector corresponding to the first task token.

20. A system, comprising:
one or more memories that store instructions, and
one or more processors that are coupled to the one or more memories and, when executing the instructions, are configured to perform the steps of:
inputting a first task token and a first set of samples included in a training dataset into a transformer neural network;
training the transformer neural network based on a first set of losses computed between a first set of outputs generated by the transformer neural network from the first task token and the first set of samples as well as a first set of labels for the first set of samples;
converting the first task token into a second task token that is larger than the first task token;
inputting the second task token and a second set of samples included in the training dataset into the transformer neural network; and
training the transformer neural network based on a second set of losses computed between a second set of outputs generated by the transformer neural network from the second task token and the second set of samples as well as a second set of labels for the second set of samples, wherein, once trained, the transformer neural network generates a third task token from at least a portion of a data sample and performs a task associated with the data sample based on the third task token.
